(19) United States
(12) Patent Application Publication
(10) Pub. No.: US 2009/0158282 A1
(43) Pub. Date: Jun. 18, 2009

(54) Hardware accelaration for large volumes of channels

(75) Inventors: James Blaisdell, Novato, CA (US); Adrian Turner, Menlo Park, CA (US)

Correspondence Address: Beyer Law Group LLP, P.O. BOX 1687, Cupertino, CA, 95015-1687, US

(73) Assignee: MOCANA CORPORATION, San Francisco, CA (US)

(21) Appl. No.: 11/660,989

(22) PCT Filed: Jul. 29, 2005
(86) PCT No.: PCT/US05/26906

§ 371 Date: Feb. 22, 2007

Related U.S. Application Data
(60) Provisional application No. 60/592,749, filed on Jul. 30, 2004.
(60) Provisional application No. 60/634,973, filed on Dec. 10, 2004.
(60) Provisional application No. 60/703,318, filed on Jul. 27, 2005.

(51) Int. Cl. G06F 9/46

(52) U.S. Cl. 718/102

(57) ABSTRACT

A method apparatus and system for hardware acceleration for large volumes of channels is described. In an embodiment, the invention is a method. The method includes monitoring an inbound queue for hardware jobs. The method further includes detecting an interrupt from a hardware component. The method also includes transferring a job from the inbound queue to the hardware component. The method may further include transferring a completed job from the hardware component to an outbound queue. The method may also include providing an indication of completion of a job in an outbound queue.

### FIELD

The present disclosure generally relates to network communications and more specifically relates to handling large numbers of channels in a network in which hardware resources are used with some packets.

### BACKGROUND

Networks may operate with a large number of devices. Such devices may be all of one type or of many different types, and may require different treatment. Typically, the large number of devices require a correspondingly large number of channels, at least one channel per device, and sometimes more. Managing these channels can be a challenge. Moreover, matching up networked devices with related channels may be a challenge.

Networks operate in real-time. Thus, when a channel is accessed, it must be found quickly. Preferably, the time to find the channel should also be predictable. With a large number of channels, accessing information on a particular channel can be slow. Moreover, allowing for additional channels can be difficult, too. Thus, it may be useful to provide a fast and predictable access time for channel information.

Moreover, in some situations, hardware acceleration may be used for processing of some packets. However, handling hardware acceleration on an interrupt driven basis can cause a driver to lose numerous packets waiting for necessary hardware, such as a cryptography accelerator for example. Hardware interrupts are unpredictable, and hardware processing is often long as compared to packet transmission time or packet latency.

The driver may be expected to wait for the hardware resource, and reject incoming packets while waiting for that resource. Alternatively, the driver may have a limited buffer for incoming packets, which may be expected to overflow during a wait for a hardware resource, thus resulting in rejection of incoming packets. Thus, handling hardware resources without requiring drivers to wait for hardware interrupts or mutexes may be useful.

### SUMMARY

A method apparatus and system for hardware acceleration for large volumes of channels is described.

In an embodiment, the invention is a method. The method includes receiving a channel identifier for a communications channel within a network. The method also includes checking the entry corresponding to the channel identifier in an array of channel entries. The array of channel entries is indexed by channel identifiers of communications channels. The method further includes operating the channel corresponding to the channel identifier. The channel is operated using channel information from the entry corresponding to the channel identifier in the array of channel entries.

In another embodiment, the invention is an apparatus. The apparatus includes a processor, a memory coupled to the processor, and a network interface coupled to the processor. The processor is to receive a channel identifier for a communications channel within a network. The processor is also to check the entry corresponding to the channel identifier in an array of channel entries. The array of channel entries is indexed by channel identifiers of communications channels. The processor is further to operate the channel corresponding to the channel identifier using channel information from the entry corresponding to the channel identifier in the array of channel entries.

In yet another embodiment, the invention is a machine-readable medium embodying instructions. The instructions are executable by a processor. The instructions are to cause a processor to perform a method. The method includes receiving a channel identifier for a communications channel within a network. The method also includes checking the entry corresponding to the channel identifier in an array of channel entries. The array of channel entries is indexed by channel identifiers of communications channels. The method further includes operating the channel corresponding to the channel identifier using channel information from the entry corresponding to the channel identifier in the array of channel entries.

In still another embodiment, the invention is an apparatus. The apparatus includes means for receiving a channel identifier. The apparatus also includes means for checking the entry corresponding to the channel identifier in an array of channel entries. The array of channel entries is indexed by channel identifiers of communications channels. The apparatus further includes means for operating the channel corresponding to the channel identifier. The means for operating uses channel information from the entry corresponding to the channel identifier in the array of channel entries.

In yet another embodiment, the invention is a method. The method includes monitoring an inbound queue for hardware jobs. The method further includes detecting an interrupt from a hardware component. The method also includes transferring a job from the inbound queue to the hardware component. The method may further include transferring a completed job from the hardware component to an outbound queue. The method may also include providing an indication of completion of a job in an outbound queue.

In still another embodiment, the invention is a method. The method includes receiving a packet on a channel of a set of channels. The method further includes determining the packet requires processing available from a hardware component. The method also includes placing the packet in an inbound queue of a dispatcher for the hardware component. The method may also include receiving a completed packet from an outbound queue of the dispatcher of the hardware component. The method may further include determining a completed packet is available on the outbound queue of the dispatcher.

The present invention is exemplified in the various embodiments described, and is limited in spirit and scope only by the appended claims.

### BRIEF DESCRIPTION OF THE DRAWINGS

The present invention is illustrated in various exemplary embodiments and is limited in spirit and scope only by the appended claims.

FIG. 1 illustrates an embodiment of a network with a hub and spokes topology.

FIG. 2 illustrates an embodiment of a hash table.

FIG. 3 illustrates an embodiment of a process of looking up a channel entry in a hash table.

FIG. 4 illustrates an embodiment of a process of looking up a channel in an array.

FIG. 5 illustrates an embodiment of an array of channel entries.

FIG. 6 illustrates an embodiment of a data structure of channel information.

FIG. 7 illustrates an embodiment of a network of machines.

FIG. 8 illustrates an embodiment of a machine or computer.

FIG. 9 illustrates an embodiment of a cellular network.

FIG. 10 illustrates an embodiment of a process of maintaining an array of channel information.

FIG. 11 illustrates an embodiment of an expanded array of channel information.

FIG. 12 illustrates an alternate embodiment of an expanded array of channel information.

FIG. 13 illustrates an embodiment of a process of maintaining a free list.

FIG. 14 illustrates an embodiment of a machine readable medium

FIG. 15 illustrates an embodiment of a free list.

FIG. 16 illustrates an embodiment of a process for handling cryptography for a message of a channel.

FIG. 17 illustrates an embodiment of a set of components which may implement the process of FIG. 16.

FIG. 18 illustrates an embodiment of a process of dispatching jobs to a hardware module.

FIG. 19 illustrates an embodiment of a process of handling packets.

FIG. 20 illustrates an embodiment of a system stack for handling packets.

FIG. 21 illustrates an embodiment of a system for handling packets including hardware acceleration.

FIG. 22 illustrates an embodiment of a representation of a job.

FIG. 23 illustrates an embodiment of a list of channels.

FIG. 24 illustrates an embodiment of a representation of a driver.

FIG. 25 illustrates an embodiment of a system including a dispatcher and a set of drivers.

FIG. 26 illustrates an alternate embodiment of a list of jobs.

FIG. 27 illustrates another embodiment of a system for handling packets including hardware acceleration.

Like reference symbols in the various drawings indicate like elements.

### DETAILED DESCRIPTION

The present invention is described and illustrated in conjunction with systems, apparatuses and methods of varying scope. In addition to the aspects of the present invention described in this summary, further aspects of the invention will become apparent by reference to the drawings and by reading the detailed description that follows. A method apparatus and system for hardware acceleration for large volumes of channels is described.

In one embodiment, the invention is a method. The method includes receiving a channel identifier for a communications channel within a network. The method also includes checking the entry corresponding to the channel identifier in an array of channel entries. The array of channel entries is indexed by channel identifiers of communications channels. The method further includes operating the channel corresponding to the channel identifier using channel information from the entry corresponding to the channel identifier in the array of channel entries.

In another embodiment, the invention is an apparatus. The apparatus includes a processor. The apparatus also includes a memory coupled to the processor. The apparatus further includes a network interface coupled to the processor. The processor is to receive a channel identifier for a communications channel within a network. The processor is further to check the entry corresponding to the channel identifier in an array of channel entries. The array of channel entries indexed by channel identifiers of communications channels. The processor is also to operate the channel corresponding to the channel identifier using channel information from the entry corresponding to the channel identifier in the array of channel entries.

In yet another embodiment, the invention is an apparatus. The apparatus includes means for receiving a channel identifier. The apparatus also includes means for checking the entry corresponding to the channel identifier in an array of channel entries. The array of channel entries is indexed by channel identifiers of communications channels. The apparatus further includes means for operating the channel corresponding to the channel identifier using channel information from the entry corresponding to the channel identifier in the array of channel entries.

In still another embodiment, the invention is a machine-readable medium embodying instructions. The instructions are executable by a processor. The instructions cause a processor to perform a method. The method includes receiving a channel identifier for a communications channel within a network. The method also includes checking the entry corresponding to the channel identifier in an array of channel entries. The array of channel entries is indexed by channel identifiers of communications channels. The method further includes operating the channel corresponding to the channel identifier using channel information from the entry corresponding to the channel identifier in the array of channel entries.

In yet another embodiment, the invention is a method The method includes monitoring an inbound queue for hardware jobs. The method further includes detecting an interrupt from a hardware component. The method also includes transferring a job from the inbound queue to the hardware component. The method may further include transferring a completed job from the hardware component to an outbound queue. The method may also include providing an indication of completion of a job in an outbound queue.

In still another embodiment, the invention is a method. The method includes receiving a packet on a channel of a set of channels. The method further includes determining the packet requires processing available from a hardware component. The method also includes placing the packet in an inbound queue of a dispatcher for the hardware component. The method may also include receiving a completed packet from an outbound queue of the dispatcher of the hardware component. The method may further include determining a completed packet is available on the outbound queue of the dispatcher.

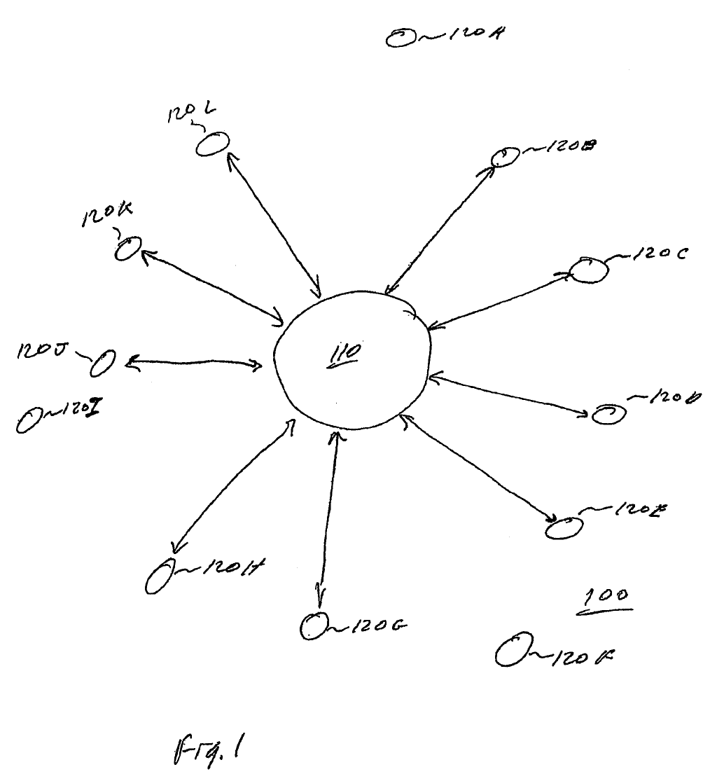

FIG. 1 illustrates an embodiment of a network with a hub and spokes topology. Network 100 may represent a variety of different types of networks. As an example, network 100 may represent a network of workstations (120) and a server 110. Thus, workstations 120b, 120c, 120d, 120e, 120g, 120h, 120j, 120k and 120l are all coupled or connected to the server 110, allowing for communication through server 110 and thus through network 100. Workstations 120a, 120f and 120i are all uncoupled from server 110, and thus are not presently integrated into network 100. Each workstation 120 may be understood to be connected or coupled to server 110 through a channel. Thus, maintaining status of channels for each workstation may be vital to the functioning of network 100.

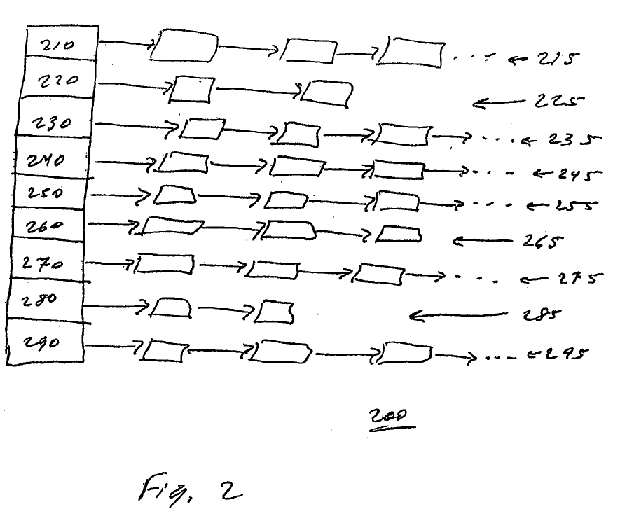

One example of a structure useful in maintaining status of channels in a network is a hash table. FIG. 2 illustrates an embodiment of a hash table. Hash table 200 includes hash buckets 210, 220, 230, 240, 250, 260, 270, 280 and 290. Each hash bucket includes a list of entries. To find an entry based on an identifier, one calculates a hash value for the identifier, and looks for the corresponding entry in the list of entries for the hash bucket identified by the hash value. Typically, a single hash value may result from many different identifiers, thus necessitating the list of entries.

As is illustrated, list of entries 215 corresponds to hash bucket 210. Similarly, list of entries 225 corresponds to hash bucket 220, list of entries 235 corresponds to hash bucket 230, list of entries 245 corresponds to hash bucket 240, and list of entries 255 corresponds to hash bucket 250. Moreover, list of entries 265 corresponds to hash bucket 260, list of entries 275 corresponds to hash bucket 270, list of entries 285 corresponds to hash bucket 280, and list of entries 295 corresponds to hash bucket 290. Lists 215, 235, 245, 255, 275 and 295 each have more than three entries, as illustrated by the ellipses. List 225 includes only two entries, as does list 285, and list 265 includes three entries. Thus, the time required to search a hash table can vary depending on both the length of the list for a hash bucket and the position in the list of the desired entry. Typically, a hash table allows for searching in o(logn) time.

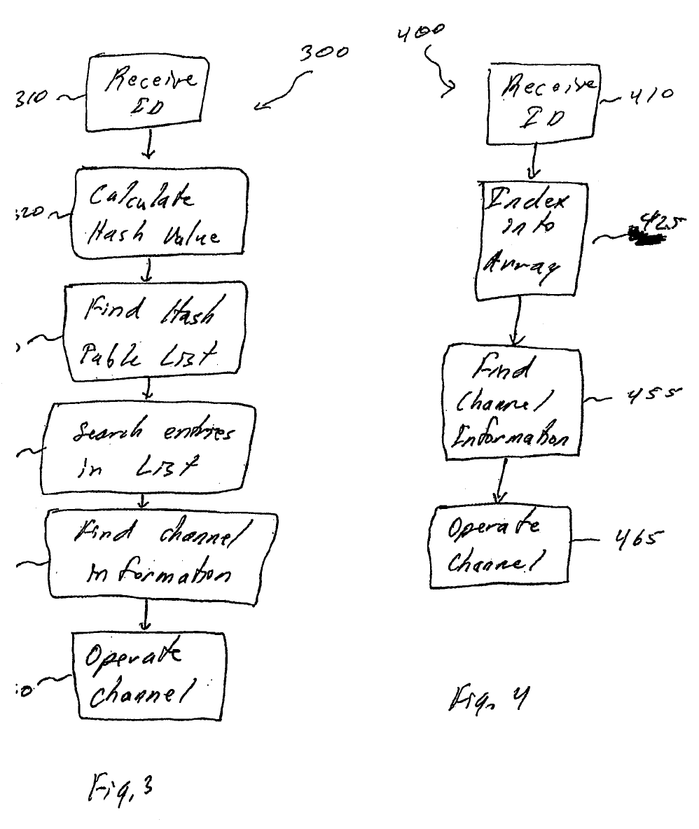

The process by which a hash table is searched provides an indication of why searching a hash table may be slow. While o(logn) time may be desirable in some applications, it can be painfully slow for real-time operations. FIG. 3 illustrates an embodiment of a process of looking up a channel entry in a hash table. The process illustrated in FIG. 3 and other processes illustrated and described include a set of modules which may be implemented in a variety of ways, allowing for parallel or serial execution. Process 300 includes receiving an identifier, finding a corresponding entry in a hash table, finding channel information of the corresponding entry, and operating the corresponding channel.

At module 310, an identifier for a channel is received. At module 320, a hash value is calculated from the identifier. At module 330, a hash table list is found based on the hash value. At module 340, entries in the hash table list are searched. At module 350, channel information for the channel is found in one of the entries of the hash table list. At module 360, the channel is operated based on the channel information of the hash table entry.

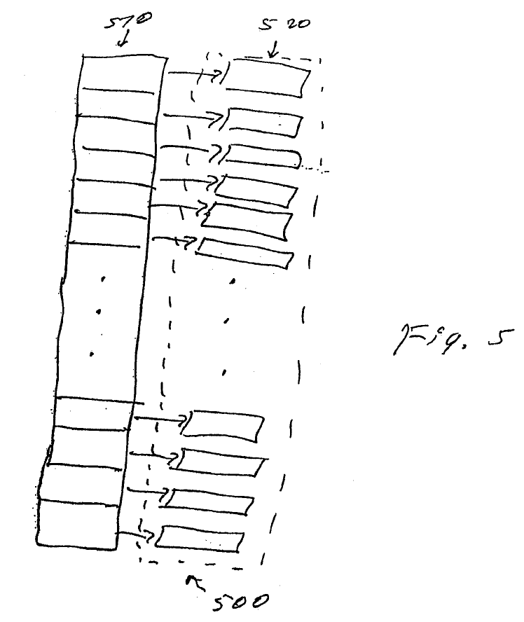

In contrast, use of an array of channel entries (or pointers to channel entries), may allow for access to channel information in O(1) time (constant time). Having constant and thus predictable time for an operation may be particularly valuable in a real-time operation. FIG. 4 illustrates an embodiment of a process of looking up a channel in an array. Process 400 includes receiving an identifier, indexing into an array, finding the channel information and operating the channel.

At module 410, an identifier for a channel is received. At module 425, the identifier is used to index directly into an array of channel information data structures. At module 455, the associated channel information for the channel is found in the array. At module 465, the associated channel is operated. Thus, if a cellular telephone transmits information on a channel within a network, the network may find control information in the channel information data structure within a constant time based on the identifier of the channel provided by the cellular telephone.

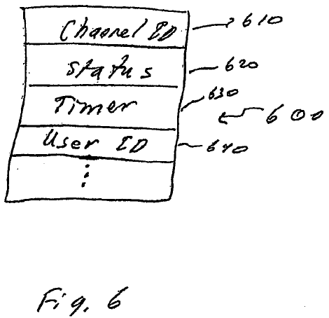

FIG. 5 illustrates an embodiment of an array of channel entries. Array 500 includes array table 510, with an entry for each identifier, and channel information data structures 520. Entries of array table 510 may be pointers to channel information data structures 520, or entries of array table 510 may be actual channel information data structures 520. FIG. 6 illustrates an embodiment of a data structure of channel information. Data structure 600 is an example or embodiment of a data structure which may be used as data structure 520. Data structure 600 includes channel identifier 610, channel status 620, channel timer 630, and user identifier 640 in one embodiment. As illustrated, further information may be included in data structure 600. Other embodiments may include different information or be organized in different ways. Moreover, different types of channels within a single network may have different associated data structures.

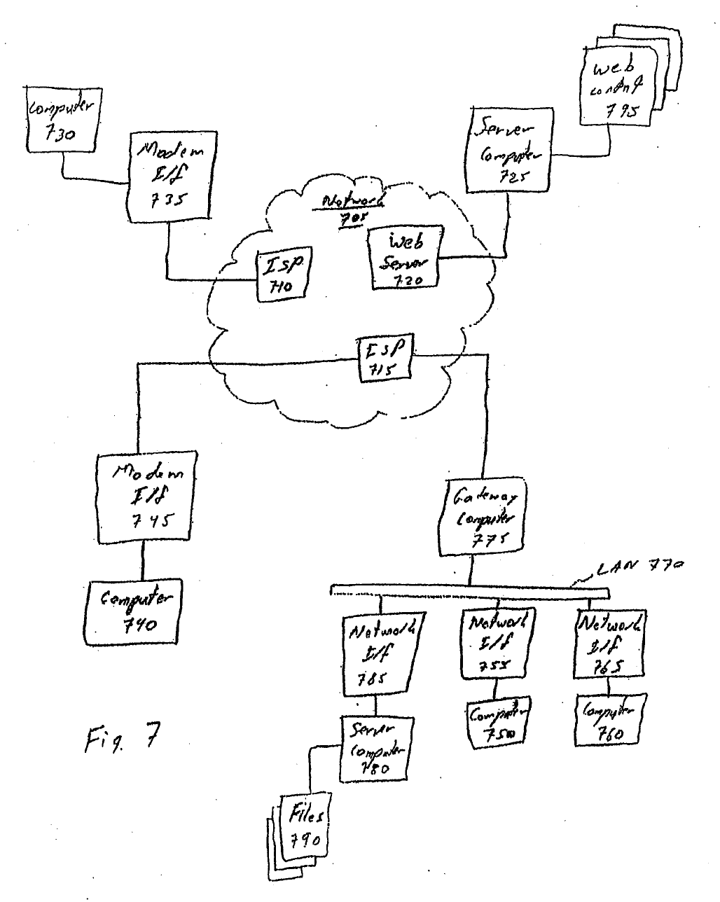

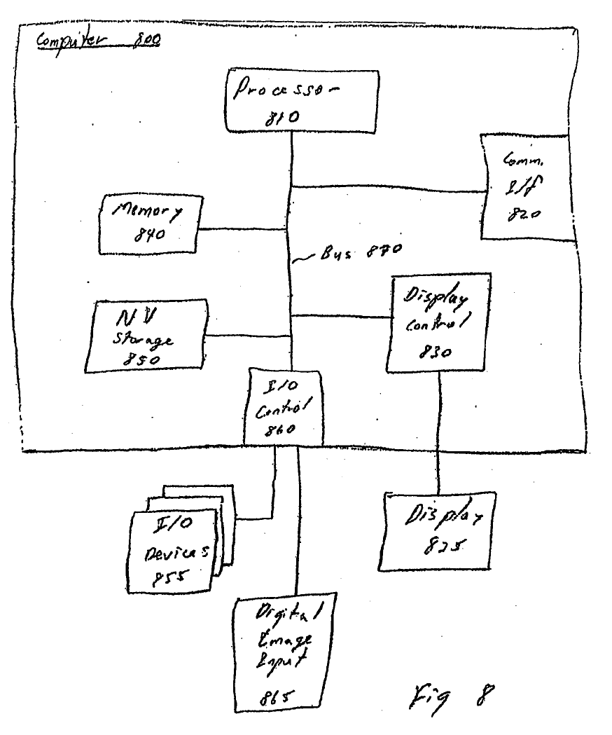

The following description of FIGS. 7-8 is intended to provide an overview of computer hardware and other operating components suitable for performing the methods of the invention described above and hereafter, but is not intended to, limit the applicable environments. Similarly, the computer hardware and other operating components may be suitable as part of the apparatuses of the invention described above. The invention can be practiced with other computer system configurations, including hand-held devices, multiprocessor systems, microprocessor-based or programmable consumer electronics, network pcs, minicomputers, mainframe computers, and the like. The invention can also be practiced in distributed computing environments where tasks are performed by remote processing devices that are linked through a communications network.

FIG. 7 shows several computer systems that are coupled together through a network 705, such as the internet. The term “internet” as used herein refers to a network of networks which uses certain protocols, such as the tcp/ip protocol, and possibly other protocols such as the hypertext transfer protocol (http) for hypertext markup language (html) documents that make up the world wide web (web). The physical connections of the internet and the protocols and communication procedures of the internet are well known to those of skill in the art.

Access to the internet 705 is typically provided by internet service providers (isp), such as the isps 710 and 715. Users on client systems, such as client computer systems 730, 740, 750, and 760 obtain access to the internet through the internet service providers, such as isps 710 and 715. Access to the internet allows users of the client computer systems to exchange information, receive and send e-mails, and view documents, such as documents which have been prepared in the html format. These documents are often provided by web servers, such as web server 720 which is considered to be “on” the internet. Often these web servers are provided by the isps, such as isp 710, although a computer system can be set up and connected to the internet without that system also being an isp.

The web server 720 is typically at least one computer system which operates as a server computer system and is configured to operate with the protocols of the world wide web and is coupled to the internet. Optionally, the web server 720 can be part of an isp which provides access to the internet for client systems. The web server 720 is shown coupled to the server computer system 725 which itself is coupled to web content 795, which can be considered a form of a media database. While two computer systems 720 and 725 are shown in FIG. 7, the web server system 720 and the server computer system 725 can be one computer system having different software components providing the web server functionality and the server functionality provided by the server computer system 725 which will be described further below.

Client computer systems 730, 740, 750, and 760 can each, with the appropriate web browsing software, view html pages provided by the web server 720. The isp 710 provides internet connectivity to the client computer system 730 through the modem interface 735 which can be considered part of the client computer system 730. The client computer system can be a personal computer system, a network computer, a web tv system, or other such computer system.

Similarly, the isp 715 provides internet connectivity for client systems 740, 750, and 760, although as shown in FIG. 7, the connections are not the same for these three computer systems. Client computer system 740 is coupled through a modem interface 745 while client computer systems 750 and 760 are part of a lan. While FIG. 7 shows the interfaces 735 and 745 as generically as a “modem,” each of these interfaces can be an analog modem, isdn modem, cable modem, satellite transmission interface (e.g. “direct pc”), or other interfaces for coupling a computer system to other computer systems.

Client computer systems 750 and 760 are coupled to a lan 770 through network interfaces 755 and 765, which can be ethernet network or other network interfaces. The lan 770 is also coupled to a gateway computer system 775 which can provide firewall and other internet related services for the local area network. This gateway computer system 775 is coupled to the isp 715 to provide internet connectivity to the client computer systems 750 and 760. The gateway computer system 775 can be a conventional server computer system Also, the web server system 720 can be a conventional server computer system Alternatively, a server computer system 780 can be directly coupled to the lan 770 through a network interface 785 to provide files 790 and other services to the clients 750, 760, without the need to connect to the internet through the gateway system 775.

FIG. 8 shows one example of a conventional computer system that can be used as a client computer system or a server computer system or as a web server system. Such a computer system can be used to perform many of the functions of an internet service provider, such as isp 710. The computer system 800 interfaces to external systems through the modem or network interface 820. It will be appreciated that the modem or network interface 820 can be considered to be part of the computer system 800. This interface 820 can be an analog modem, isdn modem, cable modem, token ring interface, satellite transmission interface (e.g. “direct pc”), or other interfaces for coupling a computer system to other computer systems.

The computer system 800 includes a processor 810, which can be a conventional microprocessor such as an intel pentium microprocessor or motorola power pc microprocessor. Memory 840 is coupled to the processor 810 by a bus 870. Memory 840 can be dynamic random access memory (dram) and can also include static ram (sram). The bus 870 couples the processor 810 to the memory 840, also to non-volatile storage 850, to display controller 830, and to the input/output (i/o) controller 860.

The display controller 830 controls in the conventional manner a display on a display device 835 which can be a cathode ray tube (crt) or liquid crystal display (lcd). The input/output devices 855 can include a keyboard, disk drives, printers, a scanner, and other input and output devices, including a mouse or other pointing device. The display controller 830 and the i/o controller 860 can be implemented with conventional well known technology. A digital image input device 865 can be a digital camera which is coupled to an i/o controller 860 in order to allow images from the digital camera to be input into the computer system 800.

The non-volatile storage 850 is often a magnetic hard disk, an optical disk, or another form of storage for large amounts of data. Some of this data is often written, by a direct memory access process, into memory 840 during execution of software in the computer system 800. One of skill in the art will immediately recognize that the terms “machine-readable medium” or “computer-readable medium” includes any type of storage device that is accessible by the processor 810 and also encompasses a carrier wave that encodes a data signal.

The computer system 800 is one example of many possible computer systems which have different architectures. For example, personal computers based on an intel microprocessor often have multiple buses, one of which can be an input/output (i/o) bus for the peripherals and one that directly connects the processor 810 and the memory 840 (often referred to as a memory bus). The buses are connected together through bridge components that perform any necessary translation due to differing bus protocols.

Network computers are another type of computer system that can be used with the present invention. Network computers do not usually include a hard disk or other mass storage, and the executable programs are loaded from a network connection into the memory 840 for execution by the processor 810. A web tv system, which is known in the art, is also considered to be a computer system according to the present invention, but it may lack some of the features shown in FIG. 8, such as certain input or output devices. A typical computer system will usually include at least a processor, memory, and a bus coupling the memory to the processor.

In addition, the computer system 800 is controlled by operating system software which includes a file management system, such as a disk operating system, which is part of the operating system software. One example of an operating system software with its associated file management system software is the family of operating systems known as Windows® from Microsoft Corporation of Redmond, Wash., and their associated file management systems. Another example of an operating system software with its associated file management system software is the LINUX operating system and its associated file management system. The file management system is typically stored in the non-volatile storage 850 and causes the processor 810 to execute the various acts required by the operating system to input and output data and to store data in memory, including storing files on the non-volatile storage 850.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention, in some embodiments, also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, cd-roms, and magnetic-optical disks, read-only memories (roms), random access memories (rams), eproms, eeproms, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language, and various embodiments may thus be implemented using a variety of programming languages.

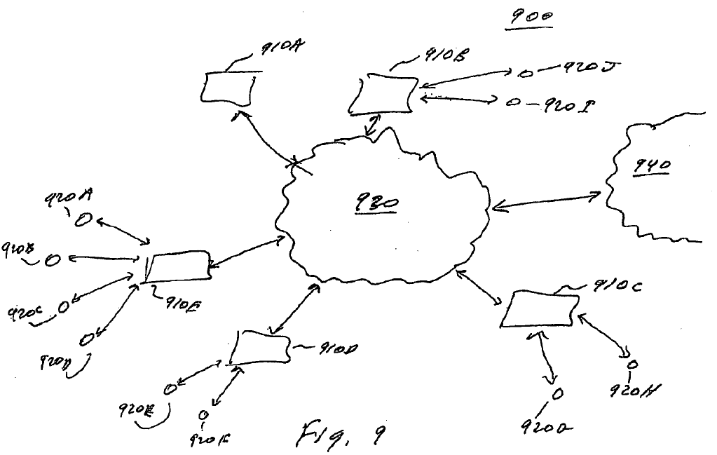

Various networks and machines such as those illustrated in FIGS. 7 and 8 may be utilized. Another type of network may be a cellular -network. FIG. 9 illustrates an embodiment of a cellular network. Network 900 includes a central network, base stations, and cellular devices. Central network 930 routes calls from one base station 910 to another base station 910 or to wireline network 940. Base stations 910 route calls to and from nearby cellular devices 920. Thus, cellular devices may communicate with other cellular devices or with devices coupled to other networks.

As illustrated, base stations 910a, 910b, 910c, 910d and 910e are all coupled to central network 930, which is also coupled to wireline network 940. Cellular devices 920a, 920b, 920c, and 920d are all coupled to base station 910e. Similarly, cellular devices 920e and 920f are coupled to base station 910d. Likewise, cellular devices 920g and 920h are coupled to base station 910c. Moreover, cellular devices 920i and 920j are coupled to base station 910b. Note that the channels in such a network may be specific to individual devices, and some devices may have multiple channels for communication in some instances. Thus, the channel at central network 930 for device 920a may be different for the channel for device 920b, even though both are coupled to base station 910e and thereby are coupled to central network 930. Moreover, a base station such as base station 910d may have its own set of channels, such as a first channel for device 920e and a second channel for device 920f for example.

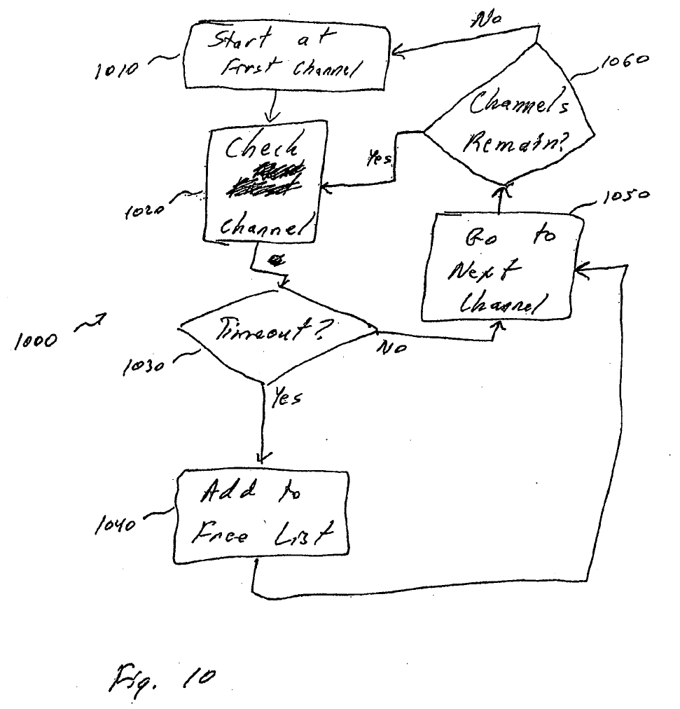

As the various communications channels of a network may be used on a constant or a sporadic basis, maintenance of information about these channels is necessary. FIG. 10 illustrates an embodiment of a process of maintaining an array of channel information. The process 1000 of FIG. 10 is illustrated with respect to determining whether a channel has timed out, but it may be applied to other forms of maintenance, such as updates of various status parameters. The process includes checking a channel, determining if it has timed out, moving timed out channels to the free list, and moving to the next channel.

At module 1010, the process starts (or restarts) at the first channel. At module 1020, the process checks the channel timer or timeout information in the array of channel data structures. This may be done in a variety of ways, including comparing a timestamp to a current time, comparing a timer field to a predetermined limit, or otherwise determining if a channel has not been used recently. At module 1030, a determination is made as to whether the check of module 1020 indicates the channel has timed out. This may vary depending on the type of channel, and some channels may be flagged such that the channel never times out. If the channel has timed out, then at module 1040, the channel is added to the free list, such as by adding it to a pointer of an entry pointed to by an end pointer. If the channel has not timed out, or after the timed out channel is added to the free list, at module 1050 the process moves to the next channel. The process then checks to see if such a next channel exists (or if the end of the array has just been passed for example) at module 1060. If a next channel exists, at module 1020 the next channel is checked. If the next channel does not exist, at module 1010 the process begins anew with the first channel.

While an array potentially allows for many channels with constant access time (in random access memory media), it can be difficult to expand. FIG. 11 illustrates an embodiment of an expanded array of channel information. Expanded array 1100 includes array entries 1110 and secondary array entries 1140. Data structures 1120 are pointed to by entries in array entries 1110. The last entry of array entries 1110 has a pointer 1130 to secondary array entries 1140. Secondary array entries 1140 has entries that point to data structures 1150, thus allowing for a second (or more) set of channels.

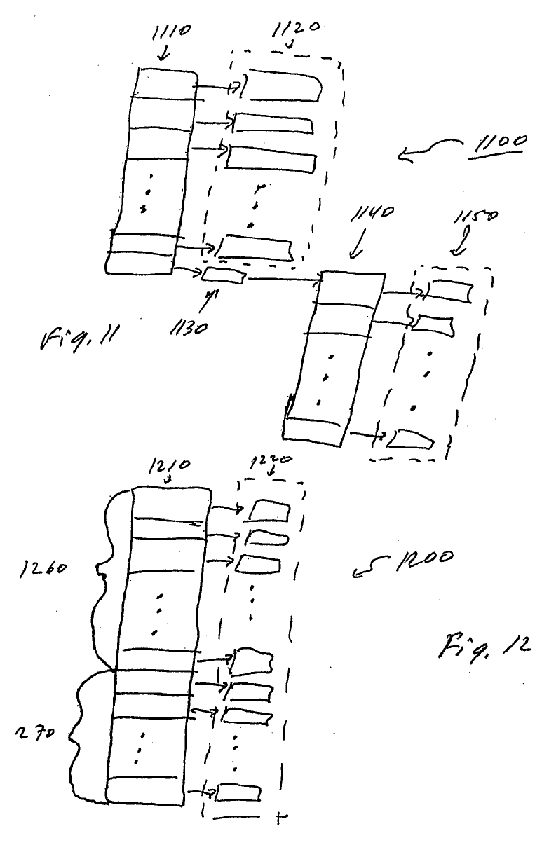

Alternatively, the simple random access nature of the array may be better preserved by simply expanding the array directly in memory. FIG. 12 illustrates an alternate embodiment of an expanded array of channel information. Array 1200 includes array entries 1210 and data structures 1220. Portion 1260 represents array entries 1210 and data structures 1220 of an original part of array 1200. Portion 1270 represents an expanded portion of array 1200. Thus, portion 1260 may correspond to an array such as array 500, with portion 1270 representing an expansion to accommodate additional channels.

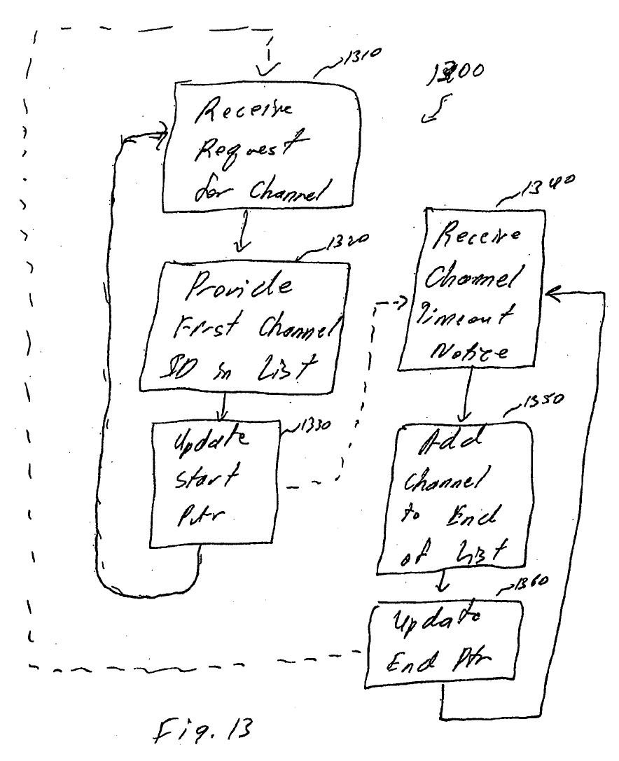

While the array may be expanded to accommodate requests for channels, it may be more efficient to reuse array entries once channels are freed from use. FIG. 13 illustrates an embodiment of a process of maintaining a free list. Process 1300 includes a process of providing channels from the free list for use and adding unused channels to a free list. At module 1310, a request is received for a channel. At module 1320, the first channel identifier from the free list is provided (such as from a start pointer for example). At module 1330, the start pointer is updated to point to the next channel of the free list, effectively removing the first channel from the free list. From module 1330, the process may move to either module 1310 or module 1340.

At module 1340, a channel timeout indication or notice is received. At module 1350, the timed out channel is added to the end of the list, such as by modifying a reference in the data structure pointed to by the end pointer to reference the timed out channel. At module 1360, the end pointer is then updated to point to the new end or last channel of the free list. From module 1360, the process may move to module 1340 or 1310. Note that the process may be viewed as two interdependent but independently executed processes, one including modules 1310, 1320, and 1330, and the other including modules 1340, 1350, and 1360.

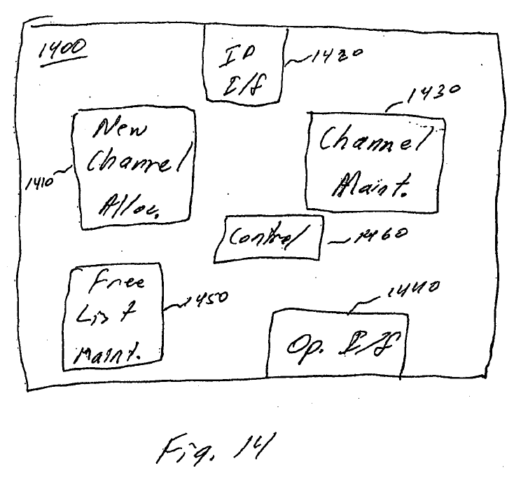

When using a machine to execute processes, the machine may be instructed (it may execute instructions) from a medium. FIG. 14 illustrates an embodiment of a machine readable medium. Medium 1400 may be of various types of media, and may be a single medium or multiple separate pieces of a single medium, or multiple media Medium 1400 includes channel maintenance, free list maintenance and new channel allocation, an identifier interface and an operations interface, and a control module.

New channel allocation 1410 may include one or both of a module for providing an expanded array of channel data structures and a module for providing new channels from the free list of channels. Free list maintenance 1450 may include a module for adding timed out/expired channels to the free list and may also include a module for providing channels from the free list. Identifier interface 1420 allows for receipt of identifiers of channels. Channel maintenance module 1430 maintains channels, such as by determining if channels are timed out or have exceeded allowable usage levels for example. Operation interface 1440 provides an interface with the portion of the network which operates the channels tracked by the array. Control module 1460 controls operation of the other modules and interfaces (1410, 1420, 1430, 1440 and 1450).

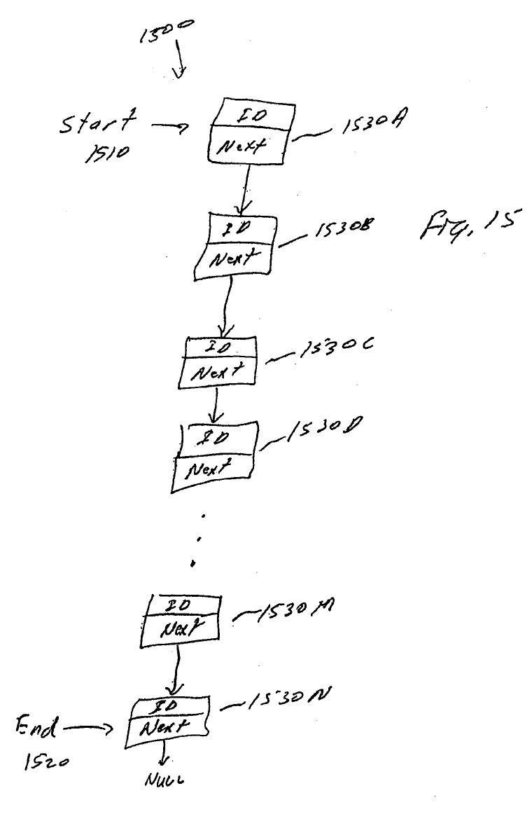

As mentioned, a free list of channels available for use or assignment may be maintained. FIG. 15 illustrates an embodiment of a free list. List 1500 is a linked list of data structures 1530, with each data structure including a channel identifier and a pointer to the next data structure. Start pointer 1510 points to the first structure 1530 (1530a as illustrated in this embodiment) of the list 1500. Thus, start pointer 1510 may indicate the least recently used channel. End pointer 1520 points to the last structure 1530 (1530n as illustrated in this embodiment) of list 1500. As illustrated, structures 1510a, 1510b, 1510c and 1510d are all linked in list 1500. The list then continues on, eventually reaching structures 1530m and 1530n. Note that with structure 1530n the last structure of the list, its pointer is assigned a null value in one embodiment.

Various devices may be used with the networks discussed herein. For example, cellular telephones and computers have been mentioned in connection with networks. However, other intelligent devices or appliances may be used with a network. Moreover, the devices may be mobile (e.g. Automobiles or construction machinery for example) or fixed (e.g. Light poles or air conditioning equipment for example). Additionally, networks may have varying topology and structure, such that channels may represent a path through a network or a direct connection for example.

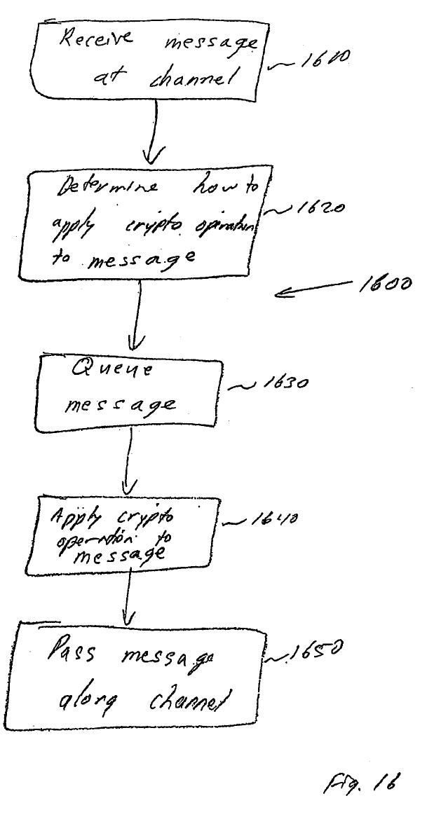

When operating the channels of some embodiments, cryptography may result in performance bottlenecks. Thus, it may be useful to handle cryptography using all available cryptography resources. FIG. 16 illustrates an embodiment of a process for handling cryptography for a message of a channel. Process 1600 includes receiving a message, determining what available cryptography resource should be applied, applying the cryptography resource, and passing the message along the channel. At module 1610, the message is received. At this point, the channel is typically known and the channel is being operated. However, in some embodiments, channel information may also be encrypted.

At module 1620, a determination is made as to what cryptography resource should be applied. For example, a hardware-based cryptography engine may handle both encryption and decryption, and software modules may be available for encryption, decryption, or handshaking/key exchange, for example. Typically, cryptography resources may be implemented in either hardware or software. The choice of which resource (hardware/software for example) to use for a cryptography operation may be based on factors such as message length and type (e.g. Content type), queue length for available resources, status of available resources (e.g. Operational, disabled), capabilities of available resources, and other factors.

At module 1630, based on the determination of module 1620, the message is queued in a queue for the selected resource. Note that a queue may be a queue of one message (the message to be operated upon) or may be a multi-message queue with or without additional priority features for example. At module 1640, the selected cryptography resource operates on the message (the message reaches the appropriate part of the queue). Operations may include encryption, decryption, key exchange or lookup, or other cryptography operations. Moreover, the operation may be determined in part by the type of message and encoding or envelope information associated therewith. At module 1650, the message is passed along the channel, in keeping with functionality of the overall system.

Process 1600 of FIG. 16 may be implemented in a variety of ways. FIG. 17 illustrates an embodiment of a set of components which may implement the process of FIG. 16. System 1700 includes hardware and software cryptography resources, a message evaluation module, and a cryptography arbitrator, all of which may interact with a message.

Hardware crypto accelerator 1710 is a hardware implementation of a cryptography resource, which may be capable of encryption, decryption and other cryptography functions. It includes queue 1720 (which may be implemented as a traditional queue or an entry for a single message/packet to be processed. Similarly, software crypto module 1730 may include encryption, decryption and other cryptographic functionality. Software crypto module 1730 may be implemented as a set of modules or software libraries and functions, for example. Queue 1740 may be a single queue for module 1730 or a set of queues (for each of several different functions, for example). Moreover, queue 1740 may be nothing more that a pointer to data for processing.

Message evaluator 1750 is a module which may evaluate properties of a message 1760 (for example), determining what type of cryptographic processing needs to occur on the message 1760 (e.g. What format is specified) and other properties of message 1760. Typically, a message 1760 will include a length parameter 1770 (e.g. A payload length for example). Cryptography arbitrator 1790 is a module which receives status information from hardware crypto accelerator 1710, software crypto module 1730, message evaluator 1750 and message 1760. Arbitrator 1790 then processes that information to determine which cryptography resource should be used for a cryptography operation on message 1760. This determination may be based on length 1770, status of queues 1720 and 1740, and other status information from accelerator 1710, module 1730 and evaluator 1750. Note that operations such as key exchange or key lookup may be performed by other resources, or by the resources illustrated in FIG. 17.

### Hardware Acceleration Implementation

In some embodiments, hardware acceleration may be used for processing of some packets. However, handling hardware acceleration on an interrupt driven basis can cause a driver to lose numerous packets waiting for necessary hardware, such as a cryptography accelerator for example. The driver may be expected to wait for the hardware resource, and reject incoming packets while waiting for that resource. Alternatively, the driver may have a limited buffer for incoming packets, which may be expected to overflow during a wait for a hardware resource, thus resulting in rejection of incoming packets. Thus, handling hardware resources without requiring drivers to wait for hardware interrupts or mutexes may be useful.

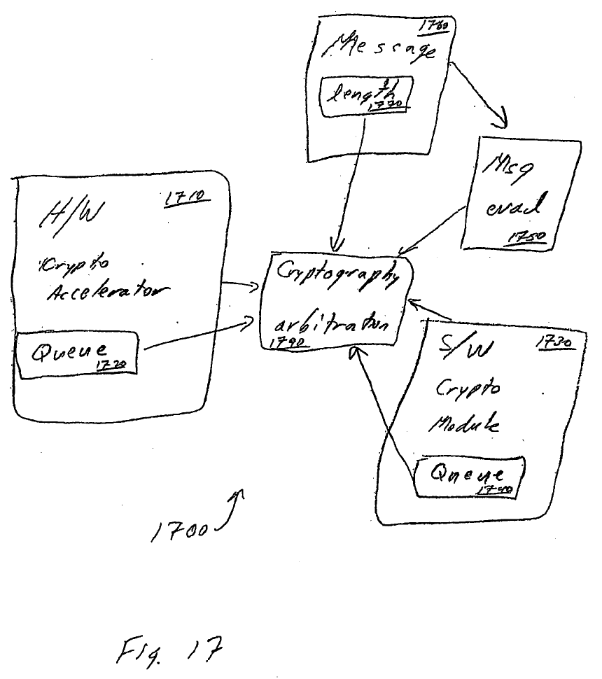

A dispatch process or dispatch module may be used to handle packets or jobs for hardware modules, without requiring drivers to specifically service hardware interrupts. FIG. 18 illustrates an embodiment of a process of dispatching jobs to a hardware module. Process 1800 includes monitoring an inbound job queue, checking for an interrupt, transferring completed jobs to an outbound job queue, and selecting an inbound job for processing.

Module 1810 includes monitoring an inbound job queue, such as determining whether a job is waiting, and which queue a job is waiting in when multiple queues are present. Module 1810 may include performance of maintenance on inbound (and potentially outbound) queue(s). At module 1820, a determination is made as to whether a hardware module (or component) has raised an interrupt. If not, the process continues to wait at module 1810. If so, at module 1830 a completed job from the hardware module is placed in an appropriate outbound queue.

At module 1840, a determination is made as to whether a job is actually waiting in an inbound queue. If not, the process monitors inbound queue(s) at module 1850, essentially waiting for an inbound job. If so, at module 1860, a next job for processing by the hardware module is selected. If only one job is present, presumably that job is selected. If multiple queues contain jobs, then a selection may be made based on priority considerations or based on an order of selection (e.g. Next in a list of queues for example) may be made. The job is provided to the hardware component for processing, and the process moves to module 1810.

Thus, a hardware component such as a cryptography accelerator may be provided a supply of jobs by a dispatcher, with incoming jobs in an incoming queue and outgoing jobs in an outgoing queue. The dispatcher may handle any interrupts raised by the hardware. Moreover, the dispatcher need not have intelligence related to the type of jobs or type of hardware component.

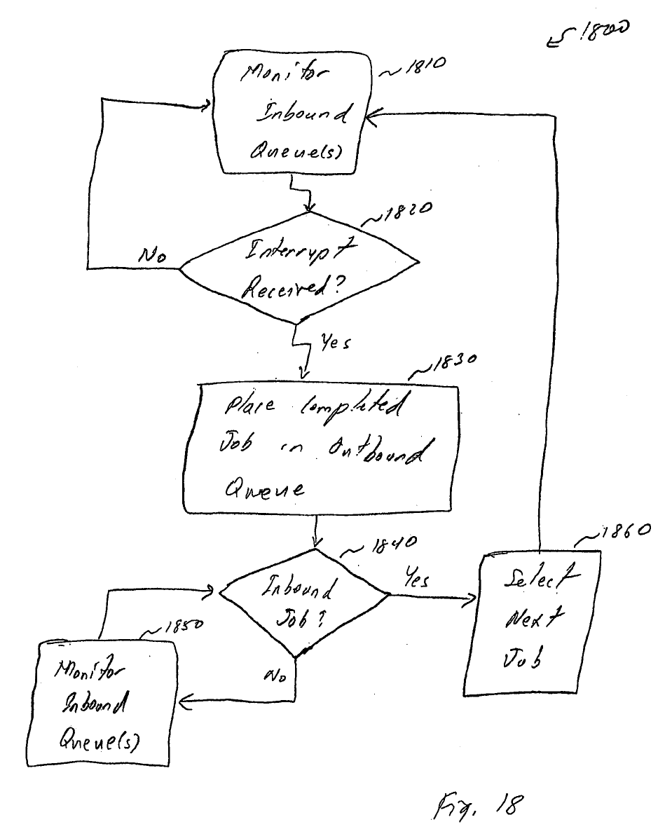

A driver may interact in a variety of ways with a dispatcher operating the process of FIG. 18. FIG. 19 illustrates an embodiment of a process of handling packets. Process 1900 may represent a process of a driver (in simplified form) for example. Process 1900 includes receiving a packet, determining if hardware acceleration is needed, placing the packet in a dispatcher queue if necessary, determining if hardware acceleration is complete, and processing a completed packet.

A packet is received at module 1910. At module 1920, a determination is made as to whether the packet requires hardware acceleration, such as cryptographic acceleration or graphics acceleration for example. If so, at module 1930, the packet is placed in a queue for a dispatcher (an inbound queue of jobs for the dispatcher) by a driver. The packet may then be expected to be processed for hardware acceleration without regard to incoming packets.

If acceleration is not needed, or after the packet is placed in the queue, at module 1940, a determination is made as to whether hardware acceleration has been completed on a packet. Note that the packet for which a determination is made at module 1940 need not be the same packet received at module 1910, it may be a packet previously received at module 1910 for example. If hardware acceleration is complete for a packet, the completed packet is processed, such as by transferring it to another part of a surrounding system, at module 1950. Ultimately, the process returns to module 1910 to await receipt of another packet.

Note that detection of completed packets from a hardware component may occur as part of a separate process. Thus, module 1940 may be implemented separately by the driver. Moreover, multiple packets may be awaiting a driver upon checking for packets completed by a hardware accelerator, thus allowing for processing of multiple packets. Additionally, packets that are not in need of hardware acceleration may also be processed immediately—without regard to the check for completed hardware acceleration for example.

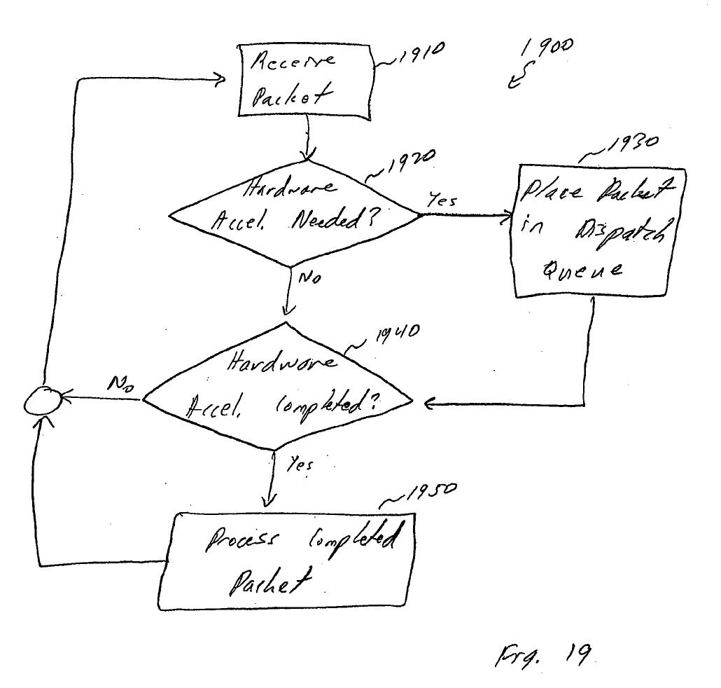

Various systems may employ or execute the methods described for handling hardware acceleration. FIG. 20 illustrates an embodiment of a system stack for handling packets. Stack 2000 is a system stack which includes software and hardware components (or software and software implementations of hardware interfaces). Stack 200 includes tls/ssl component 2005 and ssh/ire component 2010, each of which may be drivers, for example. Component 2005, in particular, may be a socket driver for example. The components 2005 and 2010 overlay tcp component 2020. Tcp component 2020 may be a transport control protocol component, for example.

Tcp component 2020, in turn, overlays ip component 2030, which may be an internet protocol module, for example. Ip component 2030 may overlay an ipsec component 2040 (an ip security component for example). Ipsec component 2040 overlays ip fragmentation component 2050 in some embodiments. Ip fragmentation component 2050 overlays an ethernet driver component 2060.

Ethernet driver component 2060 overlays a dispatcher module 2070, which may be a dispatcher for a hardware module, for example. At the base of stack 2000 is hardware 2080, including crypto accelerator 2085 and/or other hardware acceleration components or modules, among other things.

The stack 2000 may be understood as occupying three distinct areas in a system, in some embodiments. Components 2005, 2010 and 2020 are part of the user space or application space of the system. Components 2030, 2040, 2050 and 2060 are part of the kernel space of the system. Components 2070, 2080 and 2085 are part of the firmware/hardware part of the system. Moreover, note that the overlays described may refer more to interfaces between various components and an indication of datapaths rather than a physical overlay or stacking for example.

Communication between a driver such as driver 2005 and a hardware accelerator such as accelerator 2085 may be desirable, without requiring. driver 2005 to wait for a response. FIG. 21 illustrates an embodiment of a system for handling packets including hardware acceleration. Between these components, dispatcher 2070 works with one or more sets of queues, while monitoring an interrupt. Thus, driver 2005 need not wait for a hardware interrupt, and accelerator 2085 may receive jobs as available.

Dispatcher 2070 includes interrupt handler 2075, which monitors an interrupt of accelerator 2085. Accelerator 2085 may be expected to raise the interrupt either upon completion of a job or upon detection of a lack of a job to handle. Dispatcher 2070 then examines an inbound job queue such as queue 2110 for inbound jobs. Dispatcher 2070 may examine multiple queues for inbound jobs, such as by examining inbound job queue 2140 as well, for example. Moreover, dispatcher 2070 may prioritize jobs from multiple queues in a variety of ways.

Additionally, dispatcher 2070 may place a completed job (or representation thereof) in an outbound job queue such as outbound queue 2120 or 2150 for example. The sets of inbound and outbound queues are paired, with one inbound and one outbound queue for a driver, for example. Thus, a job from an inbound queue, after processing, will go to a corresponding outbound queue. For example, queues 2110 and 2120 are provided for communication with driver 2005.

Driver 2005 may examine incoming packets from a variety of channels, as represented by channel structure 2130. Channel structure 2130 may be a set of channels such as those of FIGS. 11 and 12 for example. Thus, driver 2005 may be processing data from a multitude of channels as data arrives, and directing data to hardware accelerator 2085 for processing as needed. Channel structure 2130 may have, for example, free and active lists which are maintained by driver 2005 to indicate whether a communication method monitored by driver 2005 is employed by the indicated channel at the time.

In one embodiment, the following rules between driver 2005 and dispatcher 2070 apply to the system:

Only driver 2005 may add jobs to queue 2110.

Only dispatcher 2070 may read jobs from queue 2110 (hardware schedule).

Only dispatcher 2070, responsive to interrupt handler 2075 may update queue 2120 with completed jobs or job identifiers.

Only driver 2005 may read queue 2120 (hardware completion).

Only driver 2005 may access channel list/structure 2130.

Thus, driver 2005 is responsible for populating queue 2110 (and avoiding overrun). Dispatcher 2070 is responsible for populating queue 2120. Driver 2005 may also be responsible for preventing overrun of queue 2120. Dispatcher 2070 is isolated from the channels where jobs originate and driver 2005 is isolated from the hardware interrupt of a hardware accelerator. Moreover, note that queue 2120 (and queue 2150 for example) may include job data, or a representation of a job (e.g. A cookie) along with information for where completed job data may be found, for example.

Jobs passed to a dispatcher may take on a variety of forms. FIG. 22 illustrates an embodiment of a representation of a job. Job 2200 is represented as including a driver context 2220 and a surrounding system context 2210. Thus, system context 2210 may be a wrapper provided by a surrounding system to allow for processing by a dispatcher, for example. Moreover, a payload may be part of a driver context 2220, or a separate (not shown) part of the job 2200. A dispatcher may be expected to extract data to be processed in a known manner from the job, and to direct the job back to an appropriate destination based on the two contexts. Moreover, additional processing parameters for the job may be included in one or both of the two contexts. Driver context 2220 may be expected to include channel information for purposes of the driver, too.

Various representations of a list of channels (from which jobs originate) may be used. FIG. 23 illustrates an embodiment of a list of channels. Structure 2300 is a list of channels and a set of pointers related to the list. Channel list 2350 includes a set of channels such as may be found in FIGS. 11 or 12 for example. Free pointer 2310 points to the first of a list of free channels which may be assigned for communications purposes, for example. Active pointer 2320 points to the first of a list of channels which are active, or communicating, at the moment. Both lists, as illustrated, are linked lists of channels. Channel list 2350, by contrast, may be an array of channels.

Hardware acceleration list 2330 is a pointer to a first channel which is undergoing or awaiting hardware acceleration. These are active channels which require hardware acceleration for various reasons. For example, each these channels may have a related job (or jobs) in the inbound jobs queue of a dispatcher. As illustrated, this list is a circular queue, though a simple linked list may be sufficient. Moreover, in the embodiment illustrated, hardware accelerator pointer 2340 points to the channel related to the job currently being processed by the hardware accelerator (note that this channel need not be the channel pointed to by pointer 2330). Channels may be moved between the various lists quickly, based on status of the channel.

Drivers operating in conjunction with communications channels may have various structures, too. FIG. 24 illustrates an embodiment of a representation of a driver. Driver 2400 includes a classic driver structure 2420 (e.g. A driver as supplied for a system or device) and a system structure 2410 which wraps around the driver. System structure 2410 may provide an interface between the driver 2420 and the rest of the system. However, driver 2400 may be understood as the driver within the surrounding system, even though it includes system specific components. Driver 2400 may then be expected to interface with a dispatcher and with other parts of a surrounding system.

Multiple drivers may interact with a dispatcher, for example. FIG. 25 illustrates an embodiment of a system including a dispatcher and a set of drivers. Dispatch system 2500 includes dispatcher 2510 with interrupt handler 2515. Also included are three queues (2525, 2535 and 2545) each of which corresponds to a driver (2520, 2530 and 2540 respectively). In the system illustrated, driver 2520 is an ssl driver, driver 2230 is an ssh driver and driver 2240 is an ipsec driver. Note that only the outbound queues are illustrated, for ease of illustration. In each instance, one may expect that a corresponding inbound queue also exists.

While queues may be implemented in a variety of ways, those queues shown so far have been simple linked lists. FIG. 26 illustrates an alternate embodiment of a list of jobs. Buffer 2600 is a set of jobs organized as an array 2610, which may function as a circular fifo buffer or queue, for example. Buffer 2600 also includes a dispatcher head pointer 2620, driver tail pointer 2630 and dispatcher tail pointer 2640.

In one embodiment, driver tail pointer 2630 points to the job currently being processed by the hardware accelerator. Similarly, dispatcher head pointer 2620 points to the location where new jobs may be added to the queue. Moreover, dispatcher tail pointer 2640 points to the next job to be processed by the hardware accelerator (and jobs thereafter). Thus, pointers 2620, 2630 and 2640 may march along array 2610 and thereby allow for access to inbound jobs (and potentially outbound jobs, too).

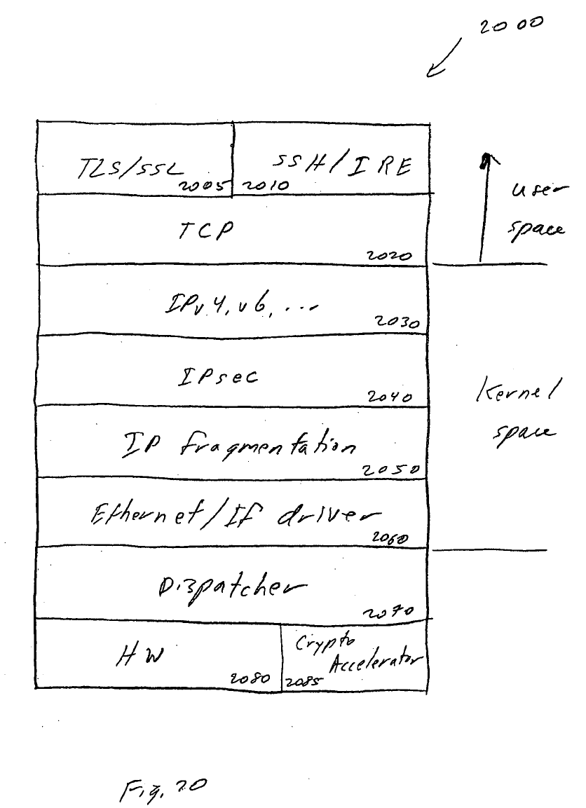

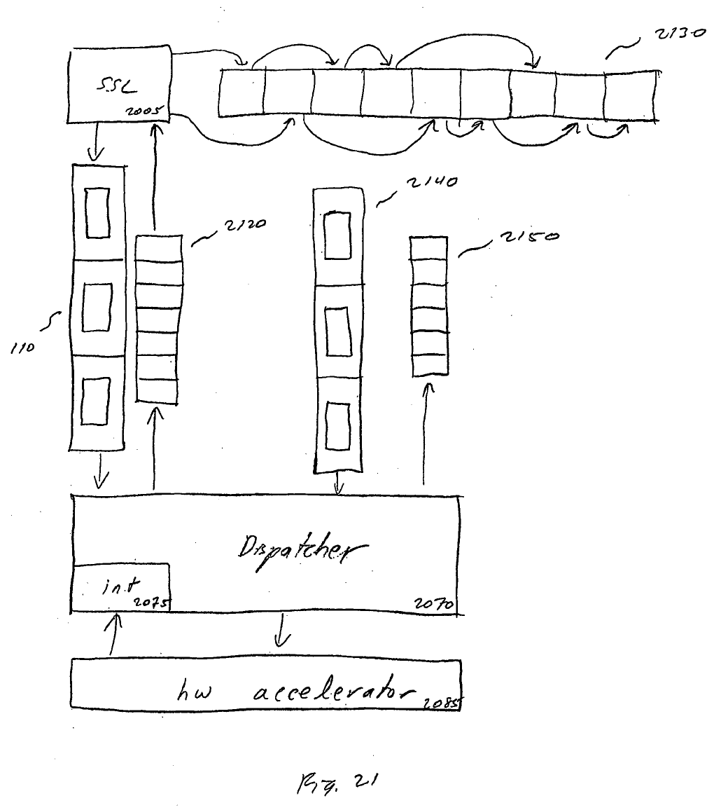

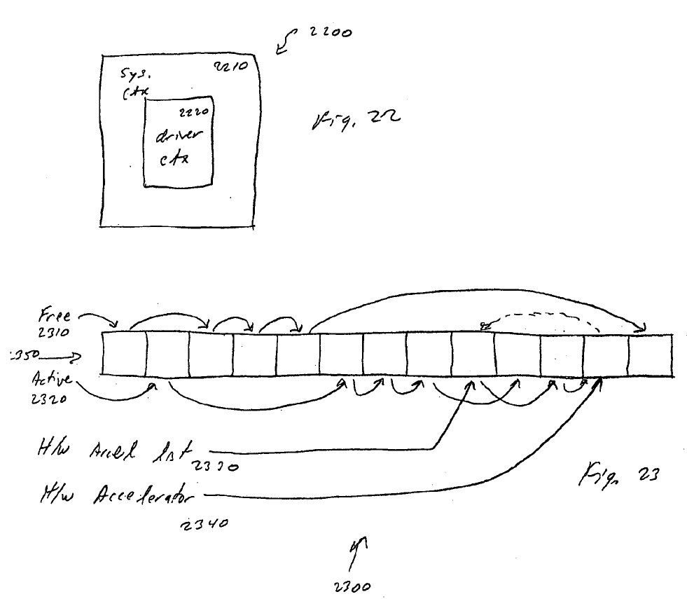

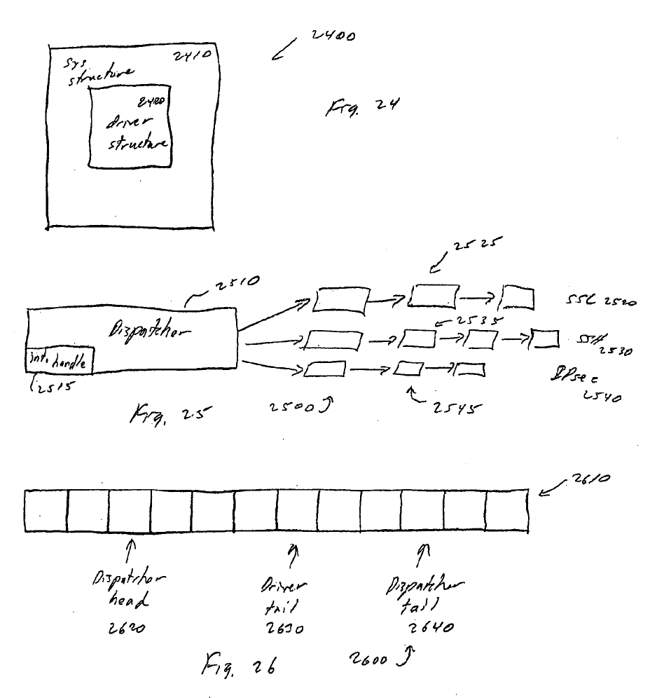

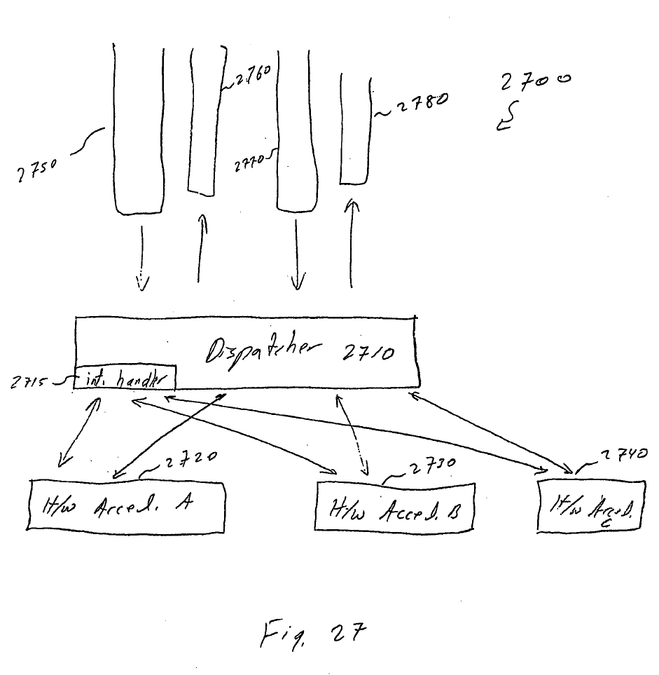

As illustrated and described, single hardware acceleration modules are used. However, multiple hardware acceleration modules may be included in a system and used in processing packets. FIG. 27 illustrates another embodiment of a system for handling packets including hardware acceleration. System 2700 includes a dispatcher, a set of hardware acceleration modules and inbound and outbound queues. In various embodiments, the acceleration modules may include graphics accelerators, cryptography accelerators, Huffman codec accelerators, and other acceleration modules, for example.

Dispatcher 2710 includes interrupt handler 2715, which monitors an interrupt of accelerators 2720, 2730 and 2740. Accelerators 2720, 2730 and 2740 may be expected to raise the interrupt either upon completion of a job or upon detection of a lack of a job to handle. Dispatcher 2710 then examines an inbound job queue such as queue 2750 for inbound jobs. Dispatcher 2710 may examine multiple queues for inbound jobs, such as by examining inbound job queue 2770 as well, for example. Moreover, dispatcher 2710 may prioritize jobs from multiple queues in a variety of ways.

In some embodiments, hardware accelerators 2720, 2730 and 2740 are each the same type of accelerator, allowing for placement of any job with any of the accelerators—meaning the next job may always be placed with the next accelerator. In other embodiments, accelerators 2720, 2730 and 2740 are of multiple different types. In some such embodiments, dispatcher 2710 may be expected to search inbound job queues for appropriate jobs when a hardware accelerator becomes available. In other such embodiments, a lack of jobs available at the dispatcher 2710 end of queues will result in a hardware module standing idle until this situation changes.

Dispatcher 2710 may also place a completed job (or representation thereof) in an outbound job queue such as outbound queue 2760 or 2780 for example; The sets of inbound and outbound queues are paired, with one inbound and one outbound queue for a driver, for example. Thus, a job from an inbound queue, after processing, will go to a corresponding outbound queue. For example, queues 2750 and 2760 are provided for communication with a single driver.

From the foregoing, it will be appreciated that specific embodiments of the invention have been described herein for purposes of illustration, but that various modifications may be made without deviating from the spirit and scope of the invention. In some instances, reference has been made to characteristics likely to be present in various or some embodiments, but these characteristics are also not necessarily limiting on the spirit and scope of the invention. In the illustrations and description, structures have been provided which may be formed or assembled in other ways within the spirit and scope of the invention. Moreover, in general, features from one embodiment may be used with other embodiments mentioned in this document provided the features are not somehow mutually exclusive.

In particular, the separate modules of the various block diagrams represent functional modules of methods or apparatuses and are not necessarily indicative of physical or logical separations or of an order of operation inherent in the spirit and scope of the present invention. Similarly, methods have been illustrated and described as linear processes, but such methods may have operations reordered or implemented in parallel within the spirit and scope of the invention. Accordingly, the invention is not limited except as by the appended claims.

1. A method, comprising:
monitoring a first inbound queue for hardware jobs;
detecting an interrupt from a first hardware component; and
transferring a job from the first inbound queue to the first hardware component.

2. The method of claim 1, further comprising:
transferring a completed job from the first hardware component to a first outbound queue.

3. The method of claim 1, further comprising:
providing an indication of completion of a job in a first outbound queue.

4. The method of claim 1, wherein:
the first hardware component is a cryptographic accelerator.

5. The method of claim 1, wherein:
the first hardware component is a graphics accelerator.

6. The method of claim 1, further comprising:
detecting an interrupt from a second hardware component; and
transferring a job from the first inbound queue to the second hardware component.

7. The method of claim 1, further comprising:
monitoring a second inbound queue for hardware jobs.

8. The method of claim 7, further comprising:
detecting an interrupt from a first hardware component; and
transferring a job from the second inbound queue to the second hardware component.

9. The method of claim 7, wherein:
the first hardware component is of a first type and the second hardware component is of a second type.

10. The method of claim 7, wherein:
the first hardware component is of a first type and the second hardware component is of the first type.

11. The method of claim 7, wherein:
the first hardware component is a cryptographic accelerator and the second hardware component is a graphics accelerator.

12. The method of claim 7, wherein:
the first hardware component is a cryptographic accelerator and the second hardware component is a cryptographic accelerator.

13. The method of claim 1, further comprising:
transferring a job from a channel through a driver into the first inbound queue.

14. The method of claim 1, further comprising:
transferring a job from the first outbound queue through a driver to a surrounding system.

15. The method of claim 13, further comprising:
detecting a packet -suitable for cryptographic acceleration from a channel in a driver.

16. The method of claim 13, further comprising:
detecting a packet suitable for hardware acceleration from a channel in a driver.

17. A method, comprising:
receiving a packet on a channel of a set of channels; determining the packet requires processing available from a hardware component; and
placing the packet in an inbound queue of a dispatcher for the hardware component.

18. The method of claim 17, further comprising:
receiving a completed packet from an outbound queue of the dispatcher of the hardware component.

19. The method of claim 17, further comprising:
determining a completed packet is available on the outbound queue of the dispatcher.

20. The method of claim 17, further comprising:
receiving an indication of a completed packet from an outbound queue of the dispatcher of the hardware component.

21. The method of claim 20, further comprising:
retrieving a completed packet from the hardware component responsive to receiving an indication of a completed packet from an outbound queue.

22. The method of claim 17, wherein:
the hardware component is a cryptographic accelerator.

23. The method of claim 17, wherein:
the hardware component is a graphics accelerator.

24-33. (canceled)

34. The medium of claim 24, wherein the method further comprises:
transferring a job from a channel through a driver into the first inbound queue.

35. The medium of claim 24, further comprising:
transferring a job from the first outbound queue through a driver to a surrounding system.

36. The medium of claim 34, wherein the method further comprises:
detecting a packet suitable for cryptographic acceleration from a channel in a driver.

37. The medium of claim 34, wherein the method further comprises:
detecting a packet suitable for hardware acceleration from a channel in a driver.

38. An apparatus, comprising:
a first hardware accelerator;
a dispatch module coupled to the first hardware accelerator including an interrupt handler;
an inbound queue coupled to the dispatch module; and
an outbound queue coupled to the dispatch module.

39. The apparatus of claim 38, further comprising:
a second hardware accelerator.

40. The apparatus of claim 39, wherein:
the first hardware accelerator is a graphics subsystem; and
the second hardware accelerator is a cryptography subsystem.

41. The apparatus of claim 38, wherein:
the dispatch module is implemented in hardware.

42. The apparatus of claim 38, wherein:
the dispatch module is implemented in software.

43. The apparatus of claim 38, wherein:
the inbound queue is implemented as a hardware FIFO.

44. The apparatus of claim 38, wherein:
the inbound queue is implemented as a software data structure.

45. The apparatus of claim 38, wherein:
the outbound queue is a hardware FIFO.

46. The apparatus of claim 38, wherein:
the outbound queue is a software data structure.

47. The apparatus of claim 38, wherein:
the first hardware accelerator is implemented in a first integrated device; and
the dispatch module is implemented in the first integrated device.

48. The apparatus of claim 38, wherein:
the first hardware accelerator is implemented in a first integrated device; and
the dispatch module is implemented in a second integrated device.

49. An apparatus, comprising:
a hardware dispatch module suitable for coupling to one or more hardware accelerators, the dispatch module including an interrupt handler;
an inbound queue coupled to the dispatch module; and
an outbound queue coupled to the dispatch module.

50. The apparatus of claim 49, wherein:
the inbound queue is implemented as a hardware FIFO; and
the outbound queue is implemented as a hardware FIFO.

51. The apparatus of claim 49, wherein:
the inbound queue is implemented as a software data structure; and
the outbound queue is implemented as a software data structure.

52. The apparatus of claim 49, further comprising:
a hardware accelerator coupled to the hardware dispatch module.

53. The apparatus of claim 52, wherein:
the hardware accelerator is implemented in a first integrated device with the hardware dispatch module.

54. The apparatus of claim 52, wherein:
the hardware accelerator is implemented in a first integrated device; and
the hardware dispatch module is implemented in a second integrated device.

55. The apparatus of claim 49, further comprising:
a first hardware accelerator coupled to the hardware dispatch module; and
a second hardware accelerator coupled to the hardware dispatch module.
